(19) United States
(12) Patent Application Publication
(10) Pub. No.: US 2024/0394413 A1
(43) Pub. Date: Nov. 28, 2024

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Kentaro OSAJIMA, Kanagawa (JP)

(73) Assignee: FUJIFILM Business Innovation Corp., Tokyo (JP)

(21) Appl. No.: 18/503,692

(22) Filed: Nov. 7, 2023

(30) Foreign Application Priority Data
May 24, 2023 (JP) 2023-085518

(51) Int. Cl. G06F 21/62

(52) U.S. Cl. CPC G06F 21/629; G06F 2221/2141

(57) ABSTRACT

An information processing system includes one or more processors configured to: when a terminal of a user is remotely connected to an image processing apparatus, identify a type of a permission granted in advance to the user, and in a case where contents of a remote operation by the terminal for the image processing apparatus fall within a scope of the permission that the user has, accept the remote operation as an enabled operation.

### CROSS-REFERENCE TO RELATED APPLICATIONS

This application is based on and claims priority under 35 USC 119 from Japanese Patent Application No. 2023-085518 filed May 24, 2023.

### BACKGROUND

### (i) Technical Field

The present disclosure relates to an information processing system, an information processing method, and a non-transitory computer readable medium.

### (ii) Related Art

A technique for connecting a mobile terminal to an image processing apparatus such as a so-called multifunction machine capable of processing including reading and printing of documents and for allowing the mobile terminal to perform a remote operation has been known (for example, Japanese Unexamined Patent Application Publication No. 2022-066044).

### SUMMARY

In the technique mentioned above, a remote operation from mobile terminals other than a mobile terminal connected to the image processing apparatus may be restricted. In this case, an exclusive operation by a user of the mobile terminal connected to the image processing apparatus is accepted, which may impair convenience of other users who share the image processing apparatus. Meanwhile, if remote operations from a plurality of mobile terminals connected to the image processing apparatus are allowed without any restrictions, an unintended operation by an unintended user may occur.

Aspects of non-limiting embodiments of the present disclosure relate to being capable of restricting an unintended operation by an unintended user even when remote operations from a plurality of mobile terminals connected to an image processing apparatus are allowed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: when a terminal of a user is remotely connected to an image processing apparatus, identify a type of a permission granted in advance to the user; and in a case where contents of a remote operation by the terminal for the image processing apparatus fall within a scope of the permission that the user has, accept the remote operation as an enabled operation.

### BRIEF DESCRIPTION OF THE DRAWINGS

Exemplary embodiments of the present disclosure will be described in detail based on the following figures, wherein:

FIG. 1 is a diagram illustrating an example of the entire configuration of an information processing system to which an exemplary embodiment is applied;

FIG. 2 is a diagram illustrating an example of the hardware configuration of an image processing apparatus;

FIG. 3 is a diagram illustrating an example of the functional configuration of a controller of the image processing apparatus;

FIG. 4 is a diagram illustrating an example of the functional configuration of a controller of a user terminal;

FIG. 5 is a flowchart illustrating the flow of a process performed when the image processing apparatus is remotely connected to a user terminal, among processes of the image processing apparatus;

FIG. 6 is a flowchart illustrating the flow of a process performed when a remote operation is performed by a user terminal, among processes of the image processing apparatus;

FIG. 7 is a flowchart illustrating the flow of a process performed when remote connection with a user terminal of a parent user is terminated, among processes of the image processing apparatus;

FIGS. 8A and 8B are diagrams illustrating specific examples of screens displayed on a display unit of the user terminal of the parent user, FIG. 8A illustrating a specific example of a screen displayed in order that an operation for designating a permission to be granted to a non-parent user remotely connected to the image processing apparatus is performed, among the screens displayed on the display unit of the user terminal of the parent user, FIG. 8B illustrating a specific example of a screen displayed in order that the parent user calls a desired user and designates a permission to be granted to the desired user, among screens displayed on the display unit of the user terminal of the parent user;

FIGS. 9A and 9B are diagrams illustrating specific examples of screens displayed on the display unit of the user terminal of the parent user, FIG. 9A illustrating a specific example of a notification screen displayed for warning in the case where a remote operation from the parent user will be rejected when a permission is granted to a non-parent user, among screens displayed on the display unit of the user terminal of the parent user, FIG. 9B illustrating a specific example of a confirmation screen displayed for warning in the case where a remote operation from the parent user will be rejected when a permission is granted to a non-parent user, among screens displayed on the display unit of the user terminal of the parent user;

FIGS. 10A and 10B are diagrams illustrating specific examples of permission information among a plurality of types of information stored in a database;

FIGS. 11A to 11C are diagrams illustrating specific examples of warning information among a plurality of types of information stored in the database; and

FIG. 12 is a diagram illustrating a specific example of template information among a plurality of types of information stored in the database.

### DETAILED DESCRIPTION

Exemplary embodiments of the present disclosure will be described in detail below with reference to accompanying drawings.

### <Configuration of Information Processing System>

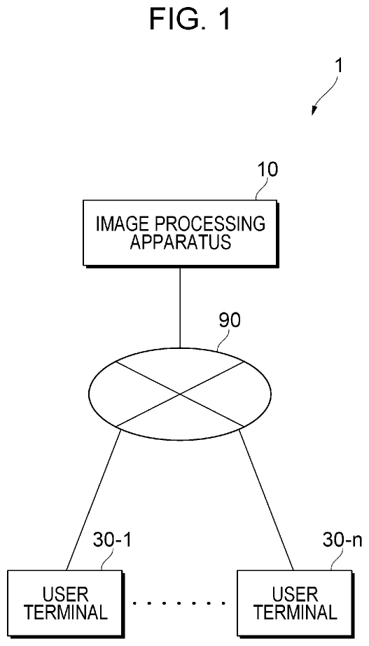

FIG. 1 is a diagram illustrating an example of the entire configuration of an information processing system 1 to which an exemplary embodiment is applied.

The information processing system 1 is configurated in such a manner that an image processing apparatus 10 and user terminals 30-1 to 30-n (n represents an integer of 1 or more) are connected via a network 90. The network 90 is, for example, a local area network (LAN), the Internet, or the like. Hereinafter, in the case where no distinction needs to be made among the user terminals 30-1 to 30-n to explain the user terminals 30-1 to 30-n, these user terminals will be referred to as “user terminals 30”.

### (Image Processing Apparatus)

The image processing apparatus 10 is an information processing apparatus that performs various types of processing in accordance with input operations by users who use the information processing system 1. For example, the image processing apparatus 10 performs processing for forming an image on a medium such as paper, processing for outputting a recording medium on which an image is formed, processing for reading an image formed on paper or other materials, and the like. The image processing apparatus 10 is, for example, a multifunction machine of a so-called electrophotographic system that forms a toner image on a printing surface of paper, a printer of a so-called inkjet system that discharges ink to a printing surface of paper, or the like.

Furthermore, the image processing apparatus 10 stores various types of information in a database and manages the various types of information. The image processing apparatus 10 also acquires various types of information transmitted from user terminals 30 operated by users and performs various types of processing. Furthermore, the image processing apparatus 10 transmits various types of information to the user terminals 30. For example, when a user terminal 30 is remotely connected to the image processing apparatus 10, the image processing apparatus 10 identifies the type of a permission granted to the user. Then, in the case where contents of a remote operation performed by the user terminal 30 for the image processing apparatus 10 fall within the scope of the permission that the user has, the image processing apparatus 10 accepts the remote operation as an enabled operation.

“Types of permissions granted in advance to users” include, for example, three levels “high”, “medium”, and “low” classified according to the priority level of permission. Furthermore, “contents of remote operations performed by user terminals 30 for the image processing apparatus 10” include, for example, operation methods such as an operation for tapping a screen, an operation for inputting on a keyboard, and the like and operation purposes such as an operation for login, an operation for changing settings, and the like. Furthermore, the image processing apparatus 10 manages contents of remote operations performed for the image processing apparatus 10, the contents of the remote operations being set in advance for individual types of permissions granted to users. The image processing apparatus 10 also manages presence or absence of rejection set in advance for contents of individual remote operations for the image processing apparatus 10.

The image processing apparatus 10 sets a user who satisfies a predetermined condition (hereinafter, referred to as a “parent user”) from among a plurality of users who have performed an operation for remotely connecting a corresponding user terminal 30 to the image processing apparatus 10. Based on the predetermined condition, for example, the image processing apparatus 10 sets the user of the first terminal that remotely connected to the image processing apparatus 10 as a parent user. In this case, in the case where there is only one user terminal 30 that is remotely connected to the image processing apparatus 10, the user of the user terminal 30 is set as a parent user. Hereinafter, users other than the parent user among a plurality of user terminals 30 that are connected to the image processing apparatus 10 may be referred to as “non-parent users”.

The image processing apparatus 10 grants a non-parent user a permission in accordance with an instruction from the set parent user. For example, in accordance with an instruction from the parent user, the image processing apparatus 10 grants a permission to a user who is individually specified by the parent user. A “user who is individually specified by a parent user” is, for example, a user who is called by the parent user in a desired manner.

In the case where remote connection with the user terminal 30 of the parent user is terminated, the image processing apparatus 10 performs processing described below. That is, in the case where a user to whom the status of the parent user is to be transferred is specified by the parent user before remote connection is terminated, the image processing apparatus 10 sets the specified user as a new parent user after termination of the remote connection.

In contrast, in the case where a user to whom the status of the parent user is to be transferred is not specified by the parent user before remote connection is terminated, the image processing apparatus 10 sets, as a new parent user, the user of the first user terminal 30 that remotely connected to the image processing apparatus 10 after the user terminal 30 of the parent user with whom remote connection has been terminated.

The image processing apparatus 10 performs control for notifying the parent user of information about non-parent users. The image processing apparatus 10 receives, as an instruction from the parent user, an instruction for granting a non-parent user a permission. The image processing apparatus 10 also receives an instruction for maintaining remote connection with the user terminal 30 of the non-parent user.

The image processing apparatus 10 performs control for notifying the parent user of information about a non-parent user to whom a permission is granted and information about a non-parent user to whom a permission is not granted, as information about non-parent users.

The image processing apparatus 10 manages information about permissions set for individual attributes of non-parent users as “template information”. In the case where an instruction for granting a permission to a non-parent user is based on template information, the image processing apparatus 10 provides a permission that matches the correspondence between an attribute and a permission that is identified from the template information. “Attributes” include, for example, a department to which a user belongs, a job title of the user, the type of the user, and the like.

In the case where a remote operation from the user terminal 30 of the parent user will be rejected on the basis of template information or one the basis of granting of a permission to a non-parent user in accordance with an instruction from the parent user, the image processing apparatus 10 performs control for notifying the parent user of information regarding a warning about the rejection of the remote operation from the user terminal 30 of the parent user (hereinafter, referred to as “warning information”).

The image processing apparatus 10 compares a permission granted to a non-parent user in accordance with an instruction from the parent user with a permission granted to the parent user, and resets a user who has a permission with a higher priority as a new parent user. Regarding a “user who has a permission with a higher priority”, for example, in the case where types of permissions are classified into “high”, “medium’, and “low”, a user who has a permission with a “high” priority level is defined as a “user who has a permission with a higher priority” with respect to a user who has a permission with a “medium” or “low” priority level. Furthermore, a user who has a permission with a “medium” priority level is defined as a “user who has a permission with a higher priority” with respect to a user who has a permission with a “low” priority level. The details of the configuration and processes of the image processing apparatus 10 will be described later.

### (User Terminal)

The user terminals 30 are mobile information processing apparatuses such as smartphones or tablet terminals operated by users who use the information processing system 1. Application software that enables operation of the image processing apparatus 10 is installed in the user terminals 30. The user terminals 30 acquire various types of information transmitted from the image processing apparatus 10 and perform various types of processing. Furthermore, the user terminals 30 transmit various types of information to the image processing apparatus 10. For example, a user terminal 30 receives an input operation for setting a permission to be granted to a non-parent user and transmits the input information to the image processing apparatus 10. Furthermore, the user terminals 30 each receive an input operation for performing a remote operation for the image processing apparatus 10 and transmit the input information to the image processing apparatus 10. Each of the user terminals 30 also displays a notification message and a confirmation message as warning information. The details of the configuration and processes of the user terminal 30 will be described later.

The configuration of the information processing system 1 described above is merely an example. The information processing system 1, only as a whole, needs to have functions for implementing the processing described above. Thus, part of or all the functions for implementing the processing described above may be distributed inside the information processing system 1 or may cooperate with each other. That is, part of or all the functions of the user terminals 30 may be provided as functions of the image processing apparatus 10 or part of or all the functions of the image processing apparatus 10 may be provided as functions of the user terminals 30. Furthermore, part of or all the functions of each of the user terminals 30 and the image processing apparatus 10 forming the information processing system 1 may be transferred to a server or other devices not illustrated in the drawing. Thus, processing as the entire information processing system 1 is promoted and a plurality of types of processing may complement each other.

### (Hardware Configuration of Image Processing Apparatus)

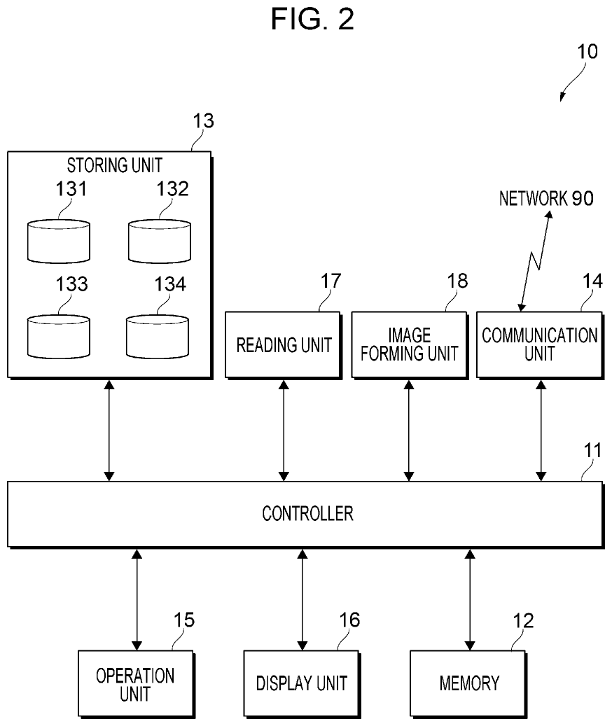

FIG. 2 is a diagram illustrating an example of the hardware configuration of the image processing apparatus 10.

The image processing apparatus 10 includes a controller 11, a memory 12, a storing unit 13, a communication unit 14, an operation unit 15, a display unit 16, a reading unit 17, and an image forming unit 18. These units are connected to one another via a data bus, an address bus, a peripheral component interconnect (PCI) bus, or the like.

The controller 11 is a processor that controls functions of the user terminals 30 by executing various types of software including operation system (OS) (basic software) and application software. The controller 11 includes, for example, a central processing unit (CPU). The memory 12 is a storage region in which various types of software, data used for execution of the various types of software, and the like are stored and is used as a work area when operation is performed. The memory 12 includes, for example, a random access memory (RAM).

The storing unit 13 is a storage region in which input data for various type of software, output data from various types of software, and the like are stored. The storing unit 13 includes, for example, a hard disk drive (HDD), a solid state drive (SSD), a semiconductor memory, and the like used for storing a program, various setting data, and the like. In the storing unit 13, as databases (DBs) that store various types of information, for example, a user DB 131 in which information about users (hereinafter, referred to as “user information”) is stored, a permission DB 132 in which information about permissions granted to users (hereinafter, referred to as “permission information”) is stored, a warning DB 133 in which warning information is stored, a template DB 134 in which template information is stored, and the like are stored.

The communication unit 14 performs data transmission and reception to and from the user terminals 30 and external devices via the network 90. The operation unit 15 includes, for example, a software keyboard, a mechanical button, a switch, and the like and receives input operations. The operation unit 15 also includes a touch sensor. The touch sensor and the display unit 16 are integrated to form a touch panel. The display unit 16 is, for example, a liquid crystal display or an organic electroluminescence (EL) display used for displaying information and displays image or text data.

The reading unit 17 reads an image recorded on a medium such as paper as a recording medium (for example, a document of a paper medium). The reading unit 17 includes, for example, a scanner of a charge coupled devices (CCD) type that reduces, with a lens, reflected light with respect to light radiated from a light source to a document and receives, with CCD, the light, a scanner of a contact image sensor (CIS) type that receives, with a CIS, reflected light with respect to light sequentially radiated from a light-emitting diode (LED) light source to a document, or the like. The image forming unit 18 forms an image to be printed on a printing surface of paper as a recording medium by, for example, an electrophotographic system or an inkjet system. These units are connected to one another via a data bus, an address bus, a PCI bus, or the like.

### (Hardware Configuration of User Terminals)

The hardware configuration of the user terminals 30 is similar to the hardware configuration of the image processing apparatus 10 illustrated in FIG. 2 with the exception of the reading unit 17 and the image forming unit 18. That is, each of the user terminals 30 includes a controller, a memory, a storing unit, a communication unit, an operation unit, and a display unit having functions similar to functions of the controller 11, the memory 12, the storing unit 13, the communication unit 14, the operation unit 15, and the display unit 16 illustrated in FIG. 2, and illustration and description of the similar units will be omitted.

### (Functional Configuration of Controller of Image Processing Apparatus)

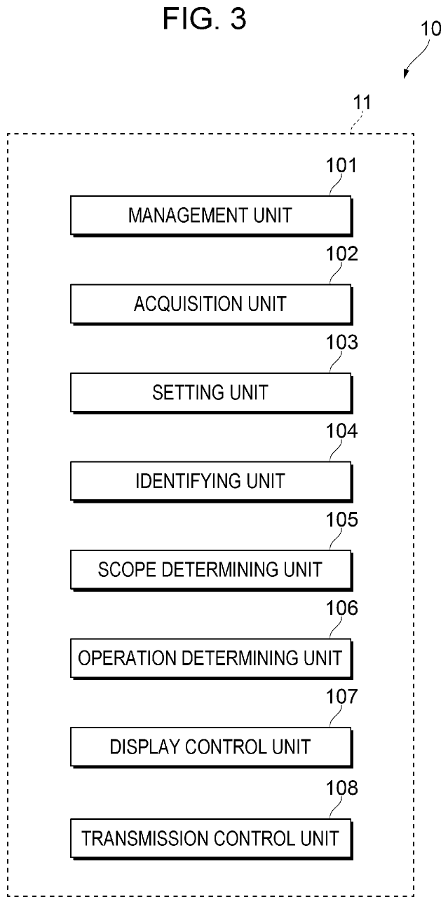

FIG. 3 is a diagram illustrating an example of the functional configuration of the controller 11 of the image processing apparatus 10.

In the controller 11 of the image processing apparatus 10, a management unit 101, an acquisition unit 102, a setting unit 103, an identifying unit 104, a scope determining unit 105, an operation determining unit 106, a display control unit 107, and a transmission control unit 108 function.

The management unit 101 stores various types of information in databases of the storing unit 13 (see FIG. 2) and manages the various types of information. For example, the management unit 101 stores user information in the user DB 131 and manages the user DB 131. The management unit 101 stores permission information in the permission DB 132 and manages the permission DB 132. Permission information is associated with user information. The management unit 101 also stores warning information in the warning DB 133 and manages the warning information. Furthermore, the management unit 101 stores template information in the template DB 134 and manages the template information.

The acquisition unit 102 acquires various types of information. For example, the acquisition unit 102 acquires input information received by the operation unit 15 (see FIG. 2) of the image processing apparatus 10. Furthermore, for example, the acquisition unit 102 acquires various types of information transmitted from the user terminals 30 and external devices. Out of a plurality of types of information acquired by the acquisition unit 102, for example, information transmitted from the user terminals 30 includes input information input to the user terminals 30. Input information acquired by the acquisition unit 102 includes, for example, information about an instruction for granting a permission to a non-parent user (hereinafter, referred to as “instruction information”), instruction information for maintaining remote connection with a user terminal 30 of the non-parent user, information input to perform a remote operation for the image processing apparatus 10, and the like.

The setting unit 103 sets a parent user from among users of the user terminals 30 that are remotely connected to the image processing apparatus 10. Specifically, when a user terminal 30 is remotely connected to the image processing apparatus 10, the setting unit 103 determines whether or not a plurality of user terminals 30 are remotely connected to the image processing apparatus 10. In the case where a plurality of user terminals 30 are remotely connected to the image processing apparatus 10, the setting unit 103 sets the user of the first user terminal 30 that remotely connected to the image processing apparatus 10 as a parent user. In contrast, in the case where only one user terminal 30 is remotely connected to the image processing apparatus 10, the setting unit 103 sets the user of the user terminal 30 remotely connected to the image processing apparatus 10 as a parent user.

Furthermore, the setting unit 103 performs setting for granting a permission to a user of a user terminal 30 that is remotely connected to the image processing apparatus 10. Specifically, in the case where template information is created, the setting unit 103 performs setting for granting a permission on the basis of the template information. In the case where template information is not created, the setting unit 103 performs setting for granting a permission on the basis of an instruction from the parent user. Specifically, the setting unit 103 performs setting for granting a permission on the basis of instruction information transmitted to the image processing apparatus 10 from the user terminal 30 of the parent user.

Furthermore, in the case where warning information is transmitted to the user terminal 30 of the parent user under the control of the transmission control unit 108 described later, the setting unit 103 performs setting for granting a permission to a non-parent user on the basis of template information or instruction information, subject to confirmation of granting of a permission from the user terminal 30 of the parent user who has received a warning.

Furthermore, in the case where the priority level of a permission that a non-parent user has is higher than the priority level of a permission that the parent user has after the permission is granted to the non-parent user on the basis of template information or instruction information, the setting unit 103 resets a parent user in accordance with whether or not variable setting is set for a parent user. Specifically, in the case where variable setting is set for a parent user, the setting unit 103 resets a non-parent user who has a permission with a higher priority than the parent user as a new parent user. In contrast, in the case where variable setting is not set for a parent user, the setting unit 103 does not change setting of the parent user.

Furthermore, when remote connection with the user terminal 30 of the parent user is terminated, the setting unit 103 confirms whether or not the status of the parent user is to be transferred. In the case where a user to whom the status of the parent user is to be transferred is specified in advance by the parent user before remote connection with the user terminal 30 of the parent user is terminated, the setting unit 103 sets, as a parent user, the user who is specified in advance as the user to whom the status of the parent user is to be transferred. In contrast, in the case where a user to whom the status of the parent user is to be transferred is not specified in advance by the parent user, the setting unit 103 searches for the first user who established remote connection after the parent user. Then, when the first user who established remote connection after the parent user is identified, the setting unit 103 sets the identified user as a parent user. In contrast, in the case where the first user who established remote connection after the parent user is not identified, the setting unit 103 determines that no parent user is necessary and does not set a parent user.

The identifying unit 104 identifies the type of a permission granted to a user of a user terminal 30 remotely connected to the image processing apparatus 10. Specifically, the identifying unit 104 identifies, based on input information about a remote operation from the user terminal 30, which is acquired by the acquisition unit 102, contents of the remote operation and the type of a permission that the user of the user terminal 30 has.

The scope determining unit 105 determines whether or not the contents of the remote operation from the user terminal 30 fall within the scope of the permission granted to the user of the user terminal 30. Specifically, the scope determining unit 105 determines whether or not the contents of the remote operation from the user terminal 30 fall within the scope of the permission identified by the identifying unit 104.

The operation determining unit 106 determines, based on the result of the determination by the scope determining unit 105, whether or not the remote operation from the user terminal 30 for the image processing apparatus 10 is to be accepted. Specifically, in the case where the operation determining unit 106 determines that the contents of the remote operation fall within the scope of the permission granted to the user who performs the remote operation, the operation determining unit 106 accepts the remote operation as an enabled operation. In contrast, in the case where the operation determining unit 106 determines that the contents of the remote operation do not fall within the scope of the permission granted to the user who performs the remote operation, the operation determining unit 106 does not accept the remote operation as an enabled operation and then rejects the remote operation.

The display control unit 107 performs control for displaying various types of information on the display unit 16 (see FIG. 2). For example, the display control unit 107 performs control for displaying a user interface for operating the image processing apparatus 10. The user interface displayed on the display unit 16 of the image processing apparatus 10 is shared on the display units of the user terminals 30 remotely connected to the image processing apparatus 10.

The transmission control unit 108 performs control for transmitting various types of information via the communication unit 14 (see FIG. 2). Specifically, the transmission control unit 108 performs control for transmitting various types of information to the user terminals 30 and external devices. For example, in the case where a remote operation from the user terminal 30 of the parent user will be rejected due to granting of a permission to a non-parent user in accordance with temperate information or in accordance with an instruction from the parent user, the transmission control unit 108 performs control for transmitting warning information to the user terminal 30 of the parent user.

In this case, the transmission control unit 108 performs control for transmitting, as warning information, any one of a notification message indicating that the remote operation from the user terminal 30 of the parent user will be rejected and a confirmation message for confirming whether or not rejection of the remote operation will be allowed, to the parent user. The transmission control unit 108 determines, based on warning information stored in the warning DB 133 (see FIG. 2), whether a notification message or a confirmation message is to be transmitted as warning information or nothing is to be transmitted.

Furthermore, the transmission control unit 108 performs control for transmitting control information for displaying various types of information on the user terminals 30. Control information for displaying various types of information on the user terminals 30 includes, for example, control information for displaying information about a non-parent user and a user interface for setting a permission to be granted to the non-parent user on the user terminal 30 of the parent user. On the user interface for setting a permission to be granted to a non-parent user, a button that allows a permission to be selected and, as information to be referenced by the parent user, for example, information about a non-parent user who is granted a permission and information about a non-parent user who is not granted a permission, are displayed.

### (Functional Configuration of User Terminals)

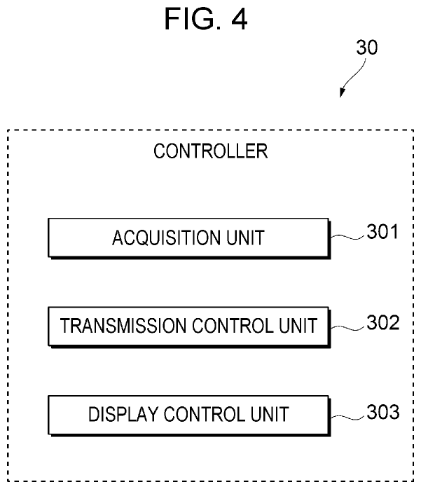

FIG. 4 is a diagram illustrating an example of the functional configuration of controllers of the user terminals 30.

In the controller of each of the user terminals 30, an acquisition unit 301, a transmission control unit 302, and a display control unit 303 function.

The acquisition unit 301 acquires various types of information. For example, the acquisition unit 301 acquires input information received by the operation unit of the user terminal 30. Furthermore, for example, the acquisition unit 301 acquires various types of information transmitted from the image processing apparatus 10 and external devices. Out of a plurality of types of information acquired by the acquisition unit 301, information transmitted from the image processing apparatus 10 includes, for example, a notification message and a confirmation message as warning information and control information for displaying a user interface for setting a permission to be grated to a non-parent user on the user terminal 30 of the parent user.

The transmission control unit 302 performs control for transmitting various types of information via the communication unit. Specifically, the transmission control unit 302 performs control for transmitting various types of information to the image processing apparatus 10 and external devices. For example, the transmission control unit 302 performs control for transmitting input information acquired by the acquisition unit 301 to the image processing apparatus 10. Input information transmitted to the image processing apparatus 10 includes, for example, information input to set a permission to be granted to a non-parent user and information input to perform a remote operation for the image processing apparatus 10.

The display control unit 303 performs control for displaying various types of information on the display unit. For example, the display control unit 303 performs control for causing an operation screen of the image processing apparatus 10 to be shared on the display unit. Furthermore, the display control unit 303 performs control for displaying information for allowing a first user to confirm that the first user and a second user have a relationship in which the second user is not the first user but secondary authentication of the second user may be permitted on the display unit.

### <Flow of Processes>

### (Flow of Processes of Image Processing Apparatus)

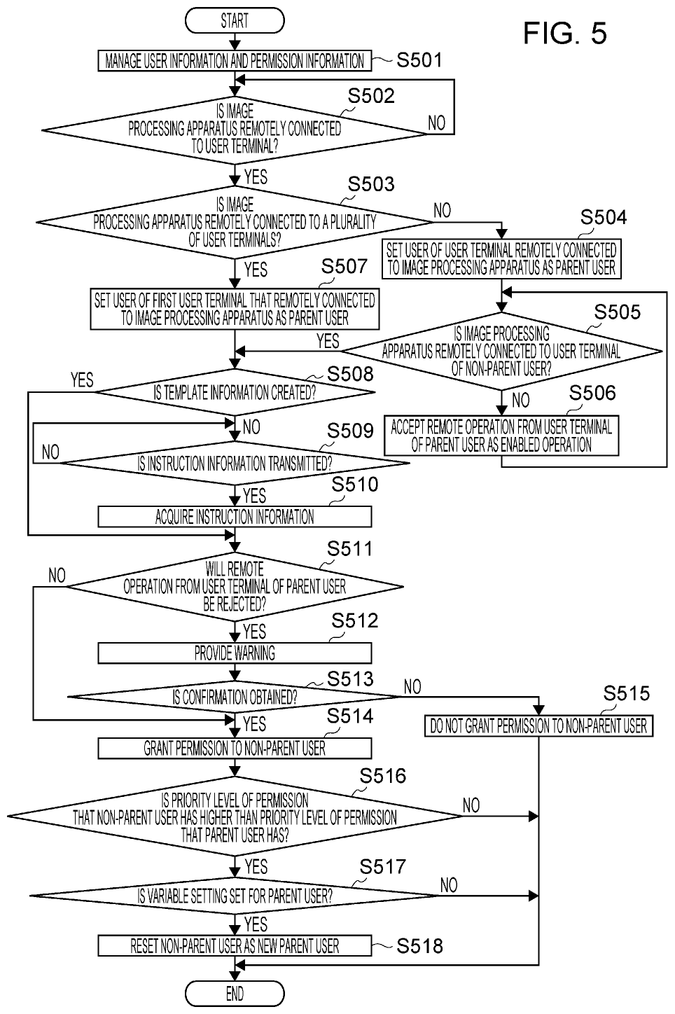

FIG. 5 is a flowchart illustrating the flow of a process performed when remote connection with a user terminal 30 is established, among processes of the image processing apparatus 10.

The image processing apparatus 10 manages user information and permission information (step 501). Specifically, the image processing apparatus 10 stores user information and permission information in the user DB 131 and the permission DB 132 of the storing unit 13 (see FIG. 2) and manages the user information and the permission information.

When the image processing apparatus 10 is remotely connected to the user terminal 30 (YES in step 502), the process proceeds to step 503. In contrast, in the case where the image processing apparatus 10 is not remotely connected to the user terminal 30 (NO in step 502), the image processing apparatus 10 repeats the determination processing of step 502 until the image processing apparatus 10 is remotely connected to the user terminal 30.

In the case where the image processing apparatus 10 is remotely connected to a plurality of user terminals 30 (YES in step 503), the image processing apparatus 10 sets the user of the first user terminal 30 that remotely connected to the image processing apparatus 10 as a parent user (step 507), and the process proceeds to determination processing of step 508. In contrast, in the case where the image processing apparatus 10 is remotely connected to only one user terminal 30 (NO in step 503), the image processing apparatus 10 sets the user of the user terminal 30 remotely connected to the image processing apparatus 10 as a parent user (step 504), and the process proceeds to determination processing of step 505.

When the image processing apparatus 10 is remotely connected to a user terminal 30 of a non-parent user as well as the user terminal 30 of the parent user remotely connected to the image processing apparatus 10 (YES in step 505), the process proceeds to determination processing of step 508. In contrast, in the case where the image processing apparatus 10 is not remotely connected to a user terminal 30 of a non-parent user (NO in step S505), the image processing apparatus 10 accepts a remote operation from the user terminal 30 of the parent user as an enabled operation (step 506), and the process returns to the determination processing of step 505.

In the case where template information for automatically granting a permission to a non-parent user of a user terminal 30 connected to the image processing apparatus 10 is created (YES in step 508), the process proceeds to determination processing of step 511. In contrast, in the case where template information for automatically granting a permission to a non-parent user is not created (NO in step 508) and instruction information is transmitted from the user terminal 30 of the parent user (YES in step 509), the image processing apparatus 10 acquires the transmitted instruction information (step 510), and the process proceeds to determination processing of step 511. Furthermore, in the case where template information for automatically granting a permission to a non-parent user is not created (NO in step 508) and no instruction information is transmitted (NO in step 509), the image processing apparatus 10 repeats the determination processing of step 509 until instruction information is transmitted.

In the case where a remote operation from the user terminal 30 of the parent user will be rejected due to granting of the permission to the non-parent user in accordance with the instruction from the parent user (YES in step 511), the image processing apparatus 10 provides a warning about the rejection to the parent user (step 512). In contrast, in the case where a remote operation from the user terminal 30 of the parent user will not be rejected (NO in step 511), the image processing apparatus 10 grants the permission to the non-parent user in accordance with the initial instruction without providing any warning (step 514).

Furthermore, in the case where the image processing apparatus 10 receives a confirmation of granting of the permission to the non-parent user from the parent user who has received the warning (YES in step 513), the image processing apparatus 10 grants the permission to the non-parent user in accordance with the initial instruction from the parent user (step 514), and the process proceeds to determination processing of step 516. In contrast, in the case where a confirmation of granting of the permission to the non-parent user is not obtained from the parent user who has received the warning (NO in step 513), the image processing apparatus 10 ends the process (END), without granting the permission to the non-parent user (step 515).

In the case where the priority level of the permission that the non-parent user has is higher than the priority level of the permission that the parent user has after the permission is granted to the non-parent user in accordance with the instruction from the parent user (YES in step 516), the image processing apparatus 10 proceeds to determination processing of step 517. In contrast, in the case where the priority level of the permission that the non-parent user has is not higher than the priority level of the permission that the parent user has (NO in step 516), the image processing apparatus 10 ends the process (END).

In the case where variable setting is set for the parent user (YES in step 517), the image processing apparatus 10 resets the non-parent user who has the permission with a higher priority than the permission that the parent user has as a new parent user (step 518), and ends the process (END). In contrast, in the case where variable setting is not set for the parent user (NO in step 517), the image processing apparatus 10 ends the process without changing setting of the parent user (END).

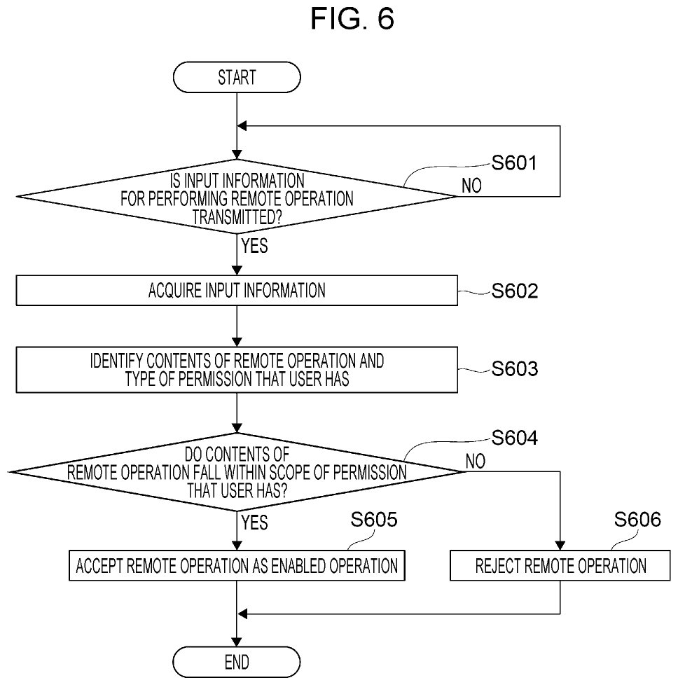

FIG. 6 is a flowchart illustrating the flow of a process performed when a remote operation by a user terminal 30 is performed, among processes of the image processing apparatus 10.

When input information for performing a remote operation is transmitted from the user terminal 30 (YES in step 601), the image processing apparatus 10 acquires the input information (step 602). Then, the image processing apparatus 10 identifies, based on the acquired input information, contents of the remote operation and the type of a permission that the user has (step 603). In contrast, in the case where input information for performing a remote operation is not transmitted (NO in step 601), the image processing apparatus 10 repeats the processing of step 601 until input information for performing a remote operation is transmitted.

Next, in the case where the contents of the remote operation by the user terminal 30 fall within the scope of the permission that the user has (YES in step 604), the image processing apparatus 10 accepts the remote operation as an enabled operation (step 605), and ends the process (END). In contrast, in the case where the contents of the remote operation do not fall within the scope of the permission that the user has (NO in step 604), the image processing apparatus 10 rejects the remote operation (step 606), and ends the process (END). That is, the image processing apparatus 10 ends the process without accepting the remote operation as an enabled operation.

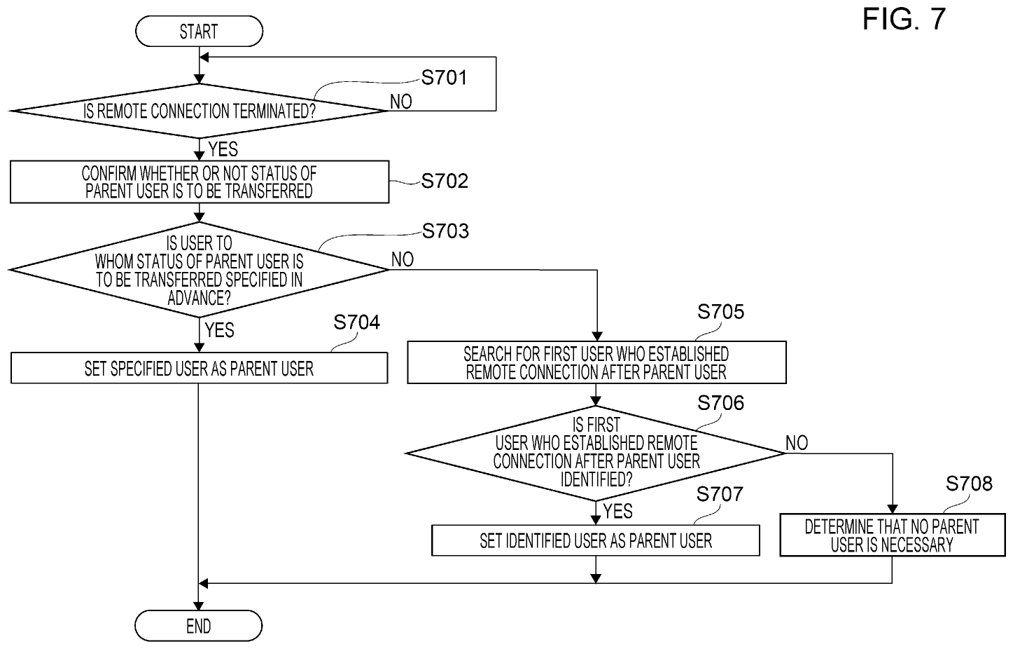

FIG. 7 is a flowchart illustrating the flow of a process performed when remote connection with the user terminal 30 of the parent user is terminated, among processes of the image processing apparatus 10.

When remote connection with the user terminal 30 of the parent user is terminated for some reason (YES in step 701), the image processing apparatus 10 confirms whether or not the status of the parent user is to be transferred (step 702). In contrast, in the case where remote connection with the user terminal 30 of the parent user is not terminated (NO in step 701), the image processing apparatus 10 repeats the determination processing of step 701 until remote connection with the user terminal 30 of the parent user is terminated.

In the case where a user to whom the status of the parent user is to be transferred is specified in advance by the parent user before the remote connection is terminated (YES in step 703), the image processing apparatus 10 sets, as a parent user, the user who is specified in advance as the user to whom the status of the parent user is to be transferred (step 704). In contrast, in the case where a user to whom the status of the parent user is to be transferred is not specified in advance by the parent user (NO in step 703), the image processing apparatus 10 searches for the first user who established remote connection after the parent user (step 705).

In the case where the first user who established remote connection after the parent user is identified (YES in step 706), the image processing apparatus 10 sets the identified user as a parent user (step 707), and ends the process (END). In contrast, in the case where the first user who established remote connection after the parent user is not identified (NO in step 706), the image processing apparatus 10 determines that no parent user is necessary (step 708), and ends the process (END).

### Specific Examples

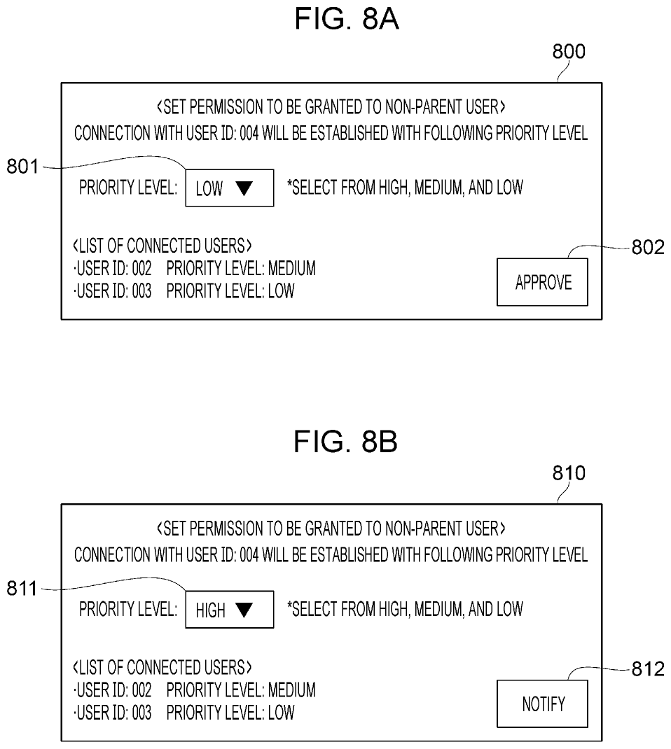

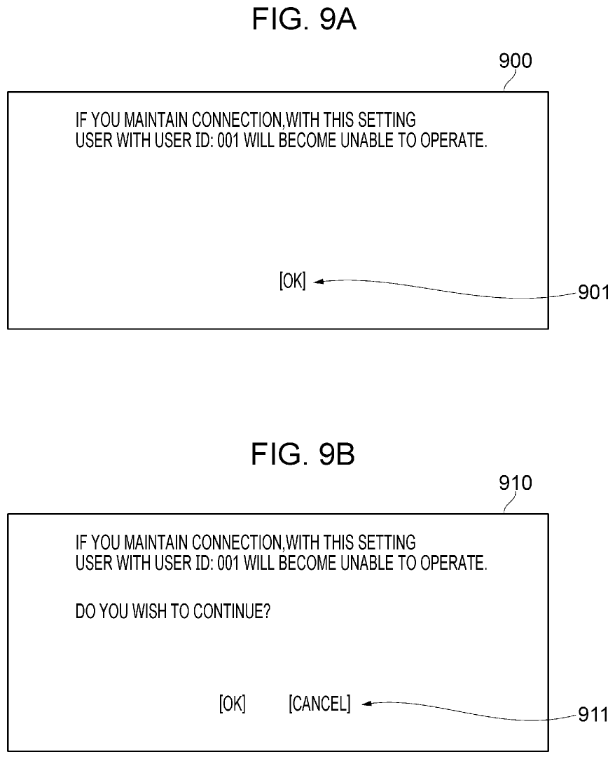

FIGS. 8A and 8B and FIGS. 9A and 9B are diagrams illustrating specific examples of screens displayed on the display unit of the user terminal 30 of the parent user.

FIG. 8A is a diagram illustrating a specific example of a screen displayed to perform an operation for designating a permission to be granted to a non-parent user who is remotely connected to the image processing apparatus 10, among screens displayed on the display unit of the user terminal 30 of the parent user.

On a screen 800 illustrated in FIG. 8A, text “Set permission to be granted to non-parent user”, a message “Connection with user ID: 004 will be established with following priority level:”, and a drop-down button 801 for selecting the priority level of a permission are displayed. The drop-down button 801 is a button for designating a permission to be granted to the user with the user ID “004”. When the parent user presses the drop-down button 801, a drop-down list, which is not illustrated in the drawing, indicating “high”, “medium”, and “low” as priority levels of permissions is displayed. In the example of FIG. 8A. “low” is selected as the priority level of a permission.

Furthermore, on the screen 800, the list of a plurality of pieces of information indicating non-parent users remotely connected to the image processing apparatus 10 is displayed along with text “list of connected users”. In the example of the screen 800, user ID and priority level of a permission are displayed as information indicating a non-parent user remotely connected to the image processing apparatus 10. Specifically, information indicating two users remotely connected to the image processing apparatus 10 is displayed in such a manner that it is easily understandable that the priority level of a permission granted to the user with the user ID “002” is “medium” and the priority level of a permission granted to the user with the user ID “003” is “low”.

Furthermore, on the screen 800, an “approve” button 802 is displayed. The parent user selects a priority level of a permission from the drop-down list that is displayed when the drop-down button 801 is pressed, and then presses the “approve” button 802. Thus, designation of the type of a permission to be granted to the non-parent user and approval of continued remote connection are performed by the parent user.

FIG. 8B is a diagram illustrating a specific example of a screen displayed in order that the parent user calls a desired user and performs an operation for designating a permission, among screens displayed on the display unit of the user terminal 30 of the parent user.

As in FIG. 8A, on a screen 810 illustrated in FIG. 8B, text “Set permission to be granted to non-parent user”, a message “Connection with user ID: 004 will be established with following priority level:”, and a drop-down button 811 for selecting the priority level of a permission are displayed. When the parent user presses the drop-down button 811, a drop-down list, which is not illustrated in the drawing, indicating “high”, “medium”, and “low” as priority levels of permissions is displayed. In the example of FIG. 8B, “high” is selected as the priority level of a permission.

Furthermore, on the screen 810, the list of a plurality of pieces of information indicating non-parent users remotely connected to the image processing apparatus 10 is displayed along with text “list of connected users”. In the example of the screen 810, user ID and priority level of a permission are displayed as information indicating a non-parent user remotely connected to the image processing apparatus 10. Specifically, as in the example illustrated in FIG. 8A, information indicating two users remotely connected to the image processing apparatus 10 is displayed in such a manner that it is easily understandable that the priority level of a permission granted to the user with the user ID “002” is “medium” and the priority level of a permission granted to the user with the user ID “003” is “low”.

Furthermore, on the screen 810, a “notify” button 812 is displayed. The parent user selects a priority level of a permission from the drop-down list that is displayed when the drop-down button 811 is pressed, and then presses the “notify” button 812. Thus, designation of the type of a permission to be granted to the non-parent user and calling of the non-parent user are performed by the parent user.

FIG. 9A is a diagram illustrating a specific example of a notification screen displayed for warning in the case where a remote operation from the parent user will be rejected due to granting of a permission to a non-parent user, among screens displayed on the display unit of the user terminal 30 of the parent user.

On a notification screen 900 illustrated in FIG. 9A, a message “If you maintain connection with this setting, the user with the user ID: 001 will become unable to operate.” as a notification to the parent user is displayed. Furthermore, a “Yes” button 901 is displayed on the notification screen 900.

FIG. 9B is a diagram illustrating a specific example of a confirmation screen displayed for warning in the case where a remote operation from the parent user will be rejected due to granting of a permission to a non-parent user, among screens displayed on the display unit of the user terminal 30 of the parent user.

On a confirmation screen 910 illustrated in FIG. 9B, warning messages “If you maintain connection with this setting, the user with the user ID: 001 will become unable to operate.” and “Do you wish to continue?” and “Yes” and “NO” buttons 911 are displayed. When the “Yes” button 911 is pressed, continued remote connection is approved, and remote connection is maintained. In contrast, when the “No” button 911 is pressed, continued remote connection is not approved, and remote connection is terminated.

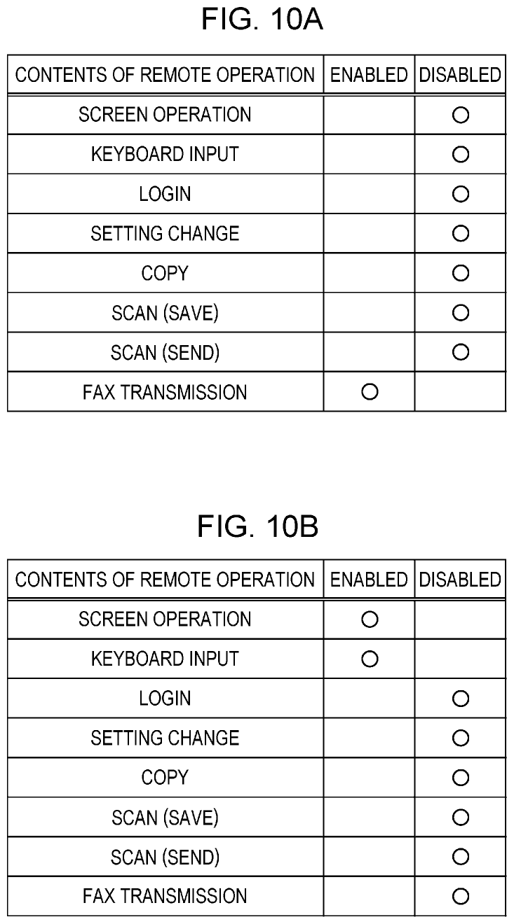

FIGS. 10A and 10B, FIGS. 11A to 11C, and FIG. 12 are diagrams illustrating specific examples of a plurality of types of information stored in the databases.

FIGS. 10A and 10B are diagrams illustrating specific examples of permission information, among the plurality of types of information stored in the databases.

In FIG. 10A, permission information about a permission with the priority level “high” is illustrated. As illustrated in FIG. 10A, the permission information about the permission with the priority level “high” indicates that contents of remote operations “screen operation”, “keyboard input”, “login”, “setting change”, “copy”, “scan (save)”, and “scan (send)” are “disabled”. Meanwhile, the permission information indicates that “fax transmission” is “enabled” (that is, not rejected). Setting of the permission information is performed by, for example, an administrator of the information processing system 1.

In FIG. 10B, permission information about a permission with the priority level “low” is illustrated. As illustrated in FIG. 10B, the permission information about the permission with the priority level “low” indicates that contents of remote operations “login”, “setting change”. “copy”, “scan (save)”, “scan (send)”, and “fax transmission” are “disabled” (that is, rejected). Meanwhile, the permission information indicates that “screen operation” and “keyboard input” are “enabled” (that is, not rejected).

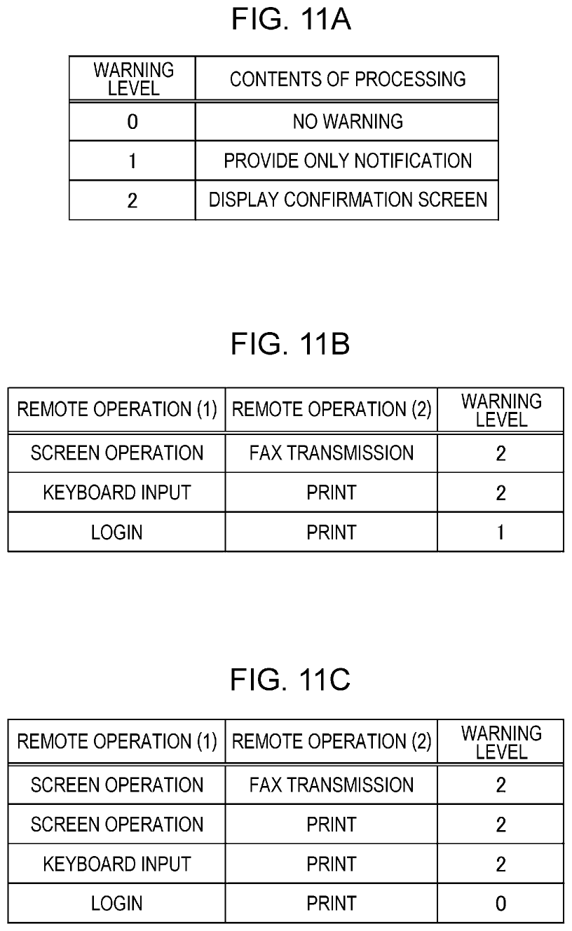

FIGS. 11A to 11C are diagrams illustrating specific examples of warning information among the plurality of types of information stored in the databases.

FIG. 11A illustrates a specific example of warning levels included in warning information. Warning information represents information in which warning level is associated with contents of processing. In FIG. 11A, as a specific example of warning levels, warning levels classified into three levels: 0, 1, and 2, are illustrated. The warning level “0” is managed as “No warning”, and the warning level “1” is managed as “Provide only notification”. “Notification” represents, for example, display of the notification screen 900 illustrated in FIG. 9A. The warning level “2” is managed as “Display confirmation screen”. The “confirmation screen” represents, for example, the confirmation screen 910 illustrated in FIG. 9B.

FIG. 11B illustrates a specific example of warning information set by default. Warning information represents information in which a combination of contents of a plurality of remote operations is associated with warning level. For example, as illustrated in FIG. 11B, warning information may be information in which a combination of contents of two remote operations is associated with warning level. In the example illustrated in FIG. 11B, a combination of “screen operation” and “fax transmission” is associated with the warning level “2”. Furthermore, a combination of “keyboard input” and “print” is associated with the warning level “2”. Moreover, a combination of “login” and “print” is associated with the warning level “1”.

For example, in the case where warning information is stored in the database, a remote operation is performed by a user terminal 30 of a user who has a permission with a priority higher than a permission that the parent user has. For example, when the remote operation performed by the user terminal 30 of the user is the combination of “screen operation” and “fax transmission”, the confirmation screen 910 illustrated in FIG. 9B is displayed on the display unit of the user terminal 30 of the parent user. For example, when the remote operation performed by the user terminal 30 of the user is the combination of “login” and “print”, the notification screen 900 illustrated in FIG. 9A is displayed on the display unit of the user terminal 30 of the parent user.

FIG. 11C illustrates a specific example of warning information that is a customized version of the warning information illustrated in FIG. 11B. In the case where warning information set by default is inconvenient from an operational point of view, contents of the warning information may be customized. For example, by customizing the warning information illustrated in FIG. 11B, warning information in which a combination of “screen operation” and “print” as contents of remote operations is associated with the warning level “2” may be added. Furthermore, among the plurality of pieces of warning information illustrated in FIG. 11B, the warning level for the combination of “login” and “print” as contents of remote operations may be changed from “1” to “0”.

Contents of warning information are not necessarily customized by the administrator of the information processing system 1 and may be customized by each user. In the case where the administrator of the information processing system 1 customizes contents of warning information, the customized contents may be applied to all the users who use the information processing system 1 after the customization of the contents of the warning information. Furthermore, in the case where a user customizes contents of warning information, the customized contents of the warning information may be applied only to the user.

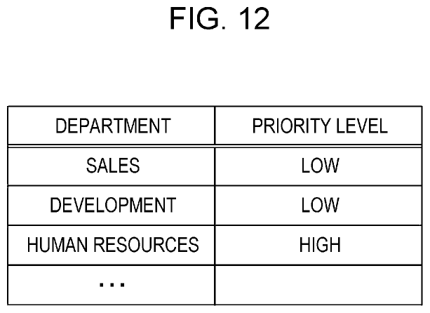

FIG. 12 is a diagram illustrating a specific example of template information among a plurality of types of information stored in the databases.

In the template information illustrated in FIG. 12, any one of “high”, “medium”, and “low” that are priority levels of permissions is associated with each “department” as an attribute of a non-parent user. Thus, for example, “low” is automatically provided as the priority level of a permission to be granted to a user who belongs to a “sales department” or a “development department”, and “high” is automatically provided as the priority level of a permission to be granted to a user who belongs to a “human resources department”. In the example of FIG. 12, although “department” is illustrated as an attribute of a non-parent user, an attribute of a non-parent user is not limited to “department” and may be, for example, information about whether or not the user has a job title, the type of the user, or the like.

In operation of template information, there may be an inconvenience in using a default value. Thus, contents of template information may be customized. Contents of template information are not necessarily customized by the administrator of the information processing system 1 and may be customized by each user. In the case where the administrator of the information processing system 1 customizes contents of template information, the customized contents may be applied to all the users who use the information processing system 1 after the customization of the contents of the template information. Furthermore, in the case where a user customizes contents of template information, the customized contents of the template information may be applied only to the user.

### Other Exemplary Embodiments

Although exemplary embodiments have been described above, the present disclosure is not limited to the exemplary embodiments described above. Furthermore, effects achieved by the present disclosure are not limited to those described in the exemplary embodiments described above. For example, the configuration of the information processing system 1 illustrated in FIG. 1 and the hardware configuration of the image processing apparatus 10 illustrated in FIG. 2 are merely illustrated as examples to attain advantages of the present disclosure and are not particularly limited. Furthermore, the functional configuration of the image processing apparatus 10 illustrated in FIG. 3 and the functional configuration of the user terminals 30 illustrated in FIG. 4 are merely examples and are not particularly limited. Functions for executing the entire processing described above only need to be provided in the information processing system 1, and functional configurations for implementing these functions are not limited to the examples illustrated in FIGS. 3 and 4.

Furthermore, orders of steps of processes of the image processing apparatus 10 illustrated in FIGS. 5 to 7 are merely examples and are not particularly limited. Processing is not necessarily performed in chronological order in the illustrated orders of steps and may be performed concurrently or individually. Furthermore, specific examples illustrated in FIGS. 8A to 12 are merely examples and are not particularly limited.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising:
one or more processors configured to:
when a terminal of a user is remotely connected to an image processing apparatus, identify a type of a permission granted in advance to the user; and
in a case where contents of a remote operation by the terminal for the image processing apparatus fall within a scope of the permission that the user has, accept the remote operation as an enabled operation.

(((2)))

The information processing system according to (((1))), wherein the one or more processors are configured to manage contents of a remote operation for the image processing apparatus set in advance for individual types of permissions.

(((3)))

The information processing system according to (((2))), wherein the one or more processors are configured to manage presence or absence of rejection set in advance for contents of individual remote operations for the image processing apparatus.

(((4))

The information processing system according to (((1))) or (((2))), wherein the one or more processors are configured to grant a permission to a non-parent user in accordance with an instruction from a parent user who satisfies a predetermined condition among a plurality of users of terminals that are remotely connected to the image processing apparatus.

(((5)))

The information processing system according to (((4))), wherein the one or more processors are configured to further grant a permission to a user who is specified individually by the parent user, in accordance with the instruction from the parent user.

(((6)))

The information processing system according to (((4))), wherein the one or more processors are configured to set a user of the first terminal that remotely connects to the image processing apparatus as the parent user and grant the permission to the non-parent user in accordance with the instruction from the parent user.

(((7)))

The information processing system according to (((6))), wherein the one or more processors are configured to, in a case where a user to whom a status of the parent user is to be transferred is specified by the parent user before remote connection with the terminal of the parent user is terminated, set, as a new parent user after termination of the remote connection with the terminal of the parent user, the user who is specified as the user to whom the status of the parent user is to be transferred.

(((8)))

The information processing system according to (((7))), wherein the one or more processors are configured to, in a case where a user to whom the status of the parent user is to be transferred is not specified, set, as a new parent user, a user of the first terminal that remotely connects to the image processing apparatus after the terminal of the parent user with whom remote connection has been terminated.

(((9)))

The information processing system according to (((4))), wherein the one or more processors are configured to:

notify the parent user of information about the non-parent user; and

receive, as the instruction from the parent user, an instruction for granting the permission to the non-parent user and an instruction for maintaining the remote connection with the terminal of the non-parent user.

(((10)))

The information processing system according to (((9))), wherein the one or more processors are configured to notify the parent user of, as the information about the non-parent user, information about a non-parent user who is granted the permission and information about a non-parent user who is not granted the permission.

(((11)))

The information processing system according to (((4))), wherein the one or more processors are configured to grant the permission to the non-parent user in accordance with an instruction for granting the non-parent user the permission set for each attribute of the non-parent user.

(((12)))

The information processing system according to (((11))), wherein the attribute includes one or more of a department to which the non-parent user belongs, a job title of the non-parent user, and a type of the non-parent user.

(((13)))

The information processing system according to any one of (((4))) to (((12))), wherein the one or more processors are configured to, in a case where the remote operation from the terminal of the parent user will be rejected due to granting of the permission to the non-parent user in accordance with the instruction from the parent user, notify the parent user of a warning indicating that the remote operation from the terminal of the parent user will be rejected.

(((14)))

The information processing system according to (((13))), wherein the one or more processors are configured to notify the parent user of, as the warning, any one of a notification message for notifying that the remote operation from the terminal of the parent user will be rejected and a confirmation message for confirming whether or not rejection of the remote operation is to be allowed.

(((15)))

The information processing system according to (((14))), wherein the one or more processors are configured to manage, based on warning level, whether the notification message or the confirmation message is to be provided as the warning for the parent user or nothing is to be provided, and perform management by associating the warning level with contents of each remote operation.

(((16)))

The information processing system according to (((15))), wherein the one or more processors are configured to perform management by associating the warning level with each combination of contents of a plurality of remote operations.

(((17)))

The information processing system according to any one of (((4))) to (((16))), wherein the one or more processors are configured to compare a permission granted to the non-parent user in accordance with the instruction from the parent user with a permission that the parent user has and reset a user who has a permission with a higher priority as a new parent user.

(((18)))

A program for causing a computer to execute:
a function for, when a terminal of a user is remotely connected to an image processing apparatus, identifying a type of a permission granted in advance to the user; and
a function for, in a case where contents of a remote operation by the terminal for the image processing apparatus fall within a scope of the permission that the user has, accepting the remote operation as an enabled operation.

What is claimed is:

1. An information processing system comprising:
one or more processors configured to:
when a terminal of a user is remotely connected to an image processing apparatus, identify a type of a permission granted in advance to the user; and
in a case where contents of a remote operation by the terminal for the image processing apparatus fall within a scope of the permission that the user has, accept the remote operation as an enabled operation.

2. The information processing system according to claim 1, wherein the one or more processors are configured to manage contents of a remote operation for the image processing apparatus set in advance for individual types of permissions.

3. The information processing system according to claim 2, wherein the one or more processors are configured to manage presence or absence of rejection set in advance for contents of individual remote operations for the image processing apparatus.

4. The information processing system according to claim 1, wherein the one or more processors are configured to grant a permission to a non-parent user in accordance with an instruction from a parent user who satisfies a predetermined condition among a plurality of users of terminals that are remotely connected to the image processing apparatus.

5. The information processing system according to claim 4, wherein the one or more processors are configured to further grant a permission to a user who is specified individually by the parent user, in accordance with the instruction from the parent user.

6. The information processing system according to claim 4, wherein the one or more processors are configured to set a user of the first terminal that remotely connects to the image processing apparatus as the parent user and grant the permission to the non-parent user in accordance with the instruction from the parent user.

7. The information processing system according to claim 6, wherein the one or more processors are configured to, in a case where a user to whom a status of the parent user is to be transferred is specified by the parent user before remote connection with the terminal of the parent user is terminated, set, as a new parent user after termination of the remote connection with the terminal of the parent user, the user who is specified as the user to whom the status of the parent user is to be transferred.

8. The information processing system according to claim 7, wherein the one or more processors are configured to, in a case where a user to whom the status of the parent user is to be transferred is not specified, set, as a new parent user, a user of the first terminal that remotely connects to the image processing apparatus after the terminal of the parent user with whom remote connection has been terminated.

9. The information processing system according to claim 4, wherein the one or more processors are configured to:
notify the parent user of information about the non-parent user; and
receive, as the instruction from the parent user, an instruction for granting the permission to the non-parent user and an instruction for maintaining the remote connection with the terminal of the non-parent user.

10. The information processing system according to claim 9, wherein the one or more processors are configured to notify the parent user of, as the information about the non-parent user, information about a non-parent user who is granted the permission and information about a non-parent user who is not granted the permission.

11. The information processing system according to claim 4, wherein the one or more processors are configured to grant the permission to the non-parent user in accordance with an instruction for granting the non-parent user the permission set for each attribute of the non-parent user.

12. The information processing system according to claim 11, wherein the attribute includes one or more of a department to which the non-parent user belongs, a job title of the non-parent user, and a type of the non-parent user.

13. The information processing system according to claim 4, wherein the one or more processors are configured to, in a case where the remote operation from the terminal of the parent user will be rejected due to granting of the permission to the non-parent user in accordance with the instruction from the parent user, notify the parent user of a warning indicating that the remote operation from the terminal of the parent user will be rejected.

14. The information processing system according to claim 13, wherein the one or more processors are configured to notify the parent user of, as the warning, any one of a notification message for notifying that the remote operation from the terminal of the parent user will be rejected and a confirmation message for confirming whether or not rejection of the remote operation is to be allowed.

15. The information processing system according to claim 14, wherein the one or more processors are configured to manage, based on warning level, whether the notification message or the confirmation message is to be provided as the warning for the parent user or nothing is to be provided, and perform management by associating the warning level with contents of each remote operation.

16. The information processing system according to claim 15, wherein the one or more processors are configured to perform management by associating the warning level with each combination of contents of a plurality of remote operations.

17. The information processing system according to claim 4, wherein the one or more processors are configured to compare a permission granted to the non-parent user in accordance with the instruction from the parent user with a permission that the parent user has, and reset a user who has a permission with a higher priority as a new parent user.

18. An information processing method comprising:
when a terminal of a user is remotely connected to an image processing apparatus, identifying a type of a permission granted in advance to the user; and
in a case where contents of a remote operation by the terminal for the image processing apparatus fall within a scope of the permission that the user has, accepting the remote operation as an enabled operation.

19. A non-transitory computer readable medium storing a program causing a computer to execute a process comprising:
when a terminal of a user is remotely connected to an image processing apparatus, identifying a type of a permission granted in advance to the user; and
in a case where contents of a remote operation by the terminal for the image processing apparatus fall within a scope of the permission that the user has, accepting the remote operation as an enabled operation.
